(19) United States
(12) Patent Application Publication
(10) Pub. No.: US 2024/0052610 A1
(43) Pub. Date: Feb. 15, 2024

(54) FLUID DISTRIBUTOR

(71) Applicant: HUSQVARNA AB, Huskvarna (SE)

(72) Inventor: Thomas Renner, Ulm (DE)

(21) Appl. No.: 18/273,094

(22) PCT Filed: Jan. 30, 2023
(86) PCT No.: PCT/EP2023/052201

§ 371 Date: Jul. 19, 2023

(30) Foreign Application Priority Data
Feb. 25, 2022 (EP) 22158691.0

(51) Int. Cl. E03C 1/02; A01G 25/16

(52) U.S. Cl. CPC E03C 1/023; A01G 25/16

(57) ABSTRACT

A fluid distributor assembly (100) includes a body (110). The body (110) defines a fluid inlet (120) adapted to receive a fluid supply from a fluid source (200). The body (110) further defines at least one fluid outlet (130) fluidly coupled with the fluid inlet (120). The at least one fluid outlet (130) is provided with a threaded portion (132) to allow fluid coupling with the fluid distribution component (500), The fluid distributor assembly (100) further includes one or more stabilizer arms (702, 800) that extend away from the body (110). The fluid distributor assembly (100) is characterized in that a first end (802) of the one or more stabilizer arm (702, 800) is removably coupled with the threaded portion (132).

### TECHNICAL FIELD

The present disclosure relates to a fluid distributor, and more particularly to the fluid distributor with a plurality of fluid outlets.

### BACKGROUND

A fluid from a fluid source (say a tap) may be required to be conveyed or carried from the fluid source to one or more fluid reservoirs for various industrial and domestic applications. Further, the fluid from the fluid source may be required to be directly used for various applications such as, but not limited to, spraying etc. To use the fluid from the fluid source for multiple applications simultaneously, a fluid distributor may be fluidly coupled to the fluid source.

The fluid distributor is a device that includes a fluid inlet and a plurality of fluid outlets. The plurality of outlets may further be connected to a plurality of fluid distribution or fluid carrying components, such that the fluid from the fluid source may be used for the execution of multiple applications simultaneously.

An example of such a fluid distributor is provided by the U.S. Pat. No. 10,781,578 (hereinafter referred to as '578 reference). The '578 reference provides a water separator with shower seat. The water separator with a shower seat includes a valve body, a frictional unit, a shower seat, and a water outflow switching mechanism. The valve body is provided with a plurality of snap-fit joints disposed circumferentially. The frictional unit is mounted on the valve body and an outer wall thereof is provided with a first frictional surface. The shower seat is provided with a connecting chamber having an open end, and a snap-fit surface and a second frictional surface are circumferentially disposed in the connecting chamber, respectively. The water outflow switching mechanism is mounted in the valve body. Hook heads of the snap-fit joints are snapped to the snap-fit surface to prevent the shower seat from getting separated from the valve body. When the shower seat rotates with respect to the valve body, the first frictional surface and the second frictional surface rotate accordingly and interact with each other. However, there is still a need for an innovative design for a fluid distributor that may stabilize or safeguard a fluid coupling between the fluid distributor and a fluid source that may otherwise be disrupted due to external factors known in the art.

EP patent application EP 2 100 669 A1 (hereinafter referred to as '669 reference) discloses a watering device. The watering device comprises a sprinkler head, a riser and a base unit. A hose is connected to the base unit at a water inlet. The base unit further comprises a riser receiving portion which is at the same time a water outlet of the base unit, and three stabilizing unit receiving portions. A respective stabilizing unit, e.g., spike stakes, etc., is fixed to each of the three stabilizing unit receiving portions. However, there is still a need for an innovative design for a fluid distributor that may stabilize or safeguard a fluid coupling between the fluid distributor and a fluid source that may otherwise be disrupted due to external factors known in the art.

U.S. Pat. No. 7,337,982 B1 (hereinafter referred to as '982 reference) discloses an irrigation device mounted to a base which supports the irrigation device. The irrigation device comprises a vertical pipe having an inlet for a first span and a second span. The portion of the vertical pipe below a sleeve is held in fixed relationship with respect to the base by means of a series of rectangular braces which tie into the angle irons and may include radially inwardly directed spokes which extend to a collar disposed on the vertical pipe to hold the vertical pipe in a fixed vertical axis. Further, the '982 reference discloses that a first end of the respective angle iron is fixed to the sleeve and an opposing second end of the respective angle iron is fixed to the rectangular frame. However, there may be a need to provide a fluid distributor that may stabilize or safeguard a fluid coupling between the fluid distributor and a fluid source that may otherwise be disrupted due to external factors known in the art.

### SUMMARY

In view of the above, it is an objective of the present invention to solve or at least reduce the drawbacks discussed above. The objective is at least partially achieved by a fluid distributor assembly. The fluid distributor assembly includes a body. The body defines a fluid inlet adapted to receive a fluid supply from a fluid source. The body further defines at least one fluid outlet fluidly coupled with the fluid inlet, wherein the at least one fluid outlet is provided with a threaded portion to allow fluid coupling with the fluid distribution component. The fluid distributor assembly further includes one or more stabilizer arms that extend away from the body. The fluid distributor assembly is characterized in that a first end of the one or more stabilizer arms is removably coupled with the threaded portion.

Thus, the fluid distribution assembly of the present disclosure advantageously provides the one or more stabilizer arms that provides stability to the fluid coupling between the fluid distributor assembly and the fluid source. The one or more stabilizer arms prevents sideways dislocation of the body of the fluid distribution assembly relative to the fluid source (say a water socket) upon establishment of the fluid coupling.

According to an embodiment which is not encompassed by the wording of the claims but is considered as useful for understanding the invention, a stabilizer frame is disposed with the body. The stabilizer frame includes one or more stabilizer arms extending away from the body. The stabilizer frame functions as a cage to provide a shelter to the fluid coupling between the fluid distributor assembly and the fluid source. The stabilizer frame additionally provides stability to the fluid coupling between the fluid distributor assembly and the fluid source against external factors.

According to an exemplary embodiment of the preset invention, the threaded portion is separately coupled to the at least one fluid outlet. In other words, the threaded portion is decouplable coupled to the at least one fluid outlet. Thereby, one fluid outlet may be used with different fluid distribution components by individually choosing a respective threaded portion most suitable for the intended application. Hence, an individually adaptable fluid distribution assembly may be providable.

According to an exemplary embodiment of the present invention, the one or more stabilizer arms are removably or permanently coupled with the fluid source. If the one or more stabilizer arms are removably coupled to the fluid source and at the same time removably coupled to the threaded portion, the one or more stabilizer arms may be replaced respectively exchanged individually dependent on, e.g., their individual state of wear. Alternatively, the one or more stabilizer arms may be replaced respectively exchanged dependent on the intended use of the at least one fluid outlet to which the stabilizer arm is coupled. Thereby, if one fluid outlet is used, e.g., for a hose with a large diameter, more forces have to be absorbed and transmitted by the one or more stabilizer arms. Hence, the one or more stabilizer arms may be interchangeable for the individual needs of the user. Alternatively, if the one or more stabilizer arms are permanently coupled with the fluid source, the stability may be increased. Thereby, a fluid distribution assembly with an increased stability may be providable.

According to an exemplary embodiment of the present invention, a second end of the one or more stabilizer arms has a substantially pointed shape and directly engages with a housing ring of the fluid source. Thereby, a force transmission may be directed and controlled. Thereby, a service life of the one or more stabilizer arms and therefore the fluid distribution assembly may be increased.

According to an embodiment of the present disclosure, the one or more stabilizer arms extends away from the body in an angular manner. The one or more stabilizer arms may provide enough space between the body and the one or more stabilizer arms due to the angular geometry to accommodate accessories such as, but not limited to, to a connector to connect or fluidly couple the fluid distributor assembly and the fluid source.

According to an embodiment which is not encompassed by the wording of the claims but is considered as useful for understanding the invention, the one or more stabilizer arms comprise a first end and a second end such that the first end is coupled to the body and the second end is coupled to a stabilizer ring. Further, the stabilizer ring is disposed circumferentially around the body. The stabilizer ring may provide rigidity to the one or more stabilizer arms. The stabilizer ring combined with the one or more stabilizer arms forms the cage structure or provides a housing for the fluid coupling between the fluid distributor assembly and the fluid source. The stabilizer ring combined with the one or more stabilizer arms may prevent disengagement in the fluid coupling due to any external factors known in the art. The external factor may be an inadvertent force generated by a foot of an operator of the fluid distribution assembly.

According to an embodiment which is not encompassed by the wording of the claims but is considered as useful for understanding the invention, the one or more stabilizer arms is three stabilizer arms. The number of the stabilizer arms in the stabilizer frame may directly be related to the strength to the stabilizer frame. The more the number of the stabilizer arms, the more is the rigidity of the stabilizer frame.

According to an embodiment which is not encompassed by the wording of the claims but is considered useful for understanding the invention, the stabilizer ring is made up of a metallic material. The metals are advantageously stronger, harder, and durable. Thus, the metallic material of the stabilizer ring may provide necessary strength and stability to the stabilizer ring and hence the stabilizer frame.

According to an embodiment which is not encompassed by the wording of the claims but is considered useful for understanding the invention, the stabilizer ring engages with a housing ring of the fluid source. The engagement may be a positive engagement that may stabilize the stabilizer frame against lateral forces due to external factors.

According to an embodiment of the present disclosure, the at least one fluid outlet is adapted to fluidly couple with one or more fluid distribution components. The at least one fluid outlet is fluidly coupled with the one or more fluid distribution components to use the fluid for multiple industrial and domestic applications simultaneously.

According to an embodiment of the present disclosure, the one or more fluid distribution components is selected from a fluid computer, a hose pipe, a connector that allows the connection of a hose, a sprinkler etc. The one or more fluid distribution components may be selected based on the application requirements, or operator preferences.

According to an embodiment of the present disclosure, the at least one fluid outlet is further provided with a manual shut-off valve. The fluid flow from the at least one outlet may be selectively controlled using the manual shut-off valve. The manual shut-off valve may be operated by the operator as per the application requirements.

According to the present invention, the at least one fluid outlet is provided with a threaded portion to allow fluid coupling with the fluid distribution component. Most of the commonly used fluid distribution components (say the hose pipe) include the threaded portion for the fluid coupling. Thus, the at least one fluid outlet is advantageously provided with the threaded portion to couple with the fluid distribution component easily and securely.

According to an embodiment of the present disclosure, the at least one fluid outlet distributes fluid in a horizontal direction. Further, the at least one fluid outlet distributes fluid in a vertical direction as well. The at least one fluid outlet advantageously distributes the fluid in both the horizontal as well as the vertical directions. The operator may selectively couple the fluid distribution components in the horizontal direction or the vertical direction or both the directions as per the application requirements. The operator may not be forced to fluidly couple the fluid distribution component such as a flexible hose pipe in the vertical direction, which may sometimes lead to unwanted turning or twisting of the flexible hose pipe and make the flexible hose pipe less durable.

Other features and aspects of this invention will be apparent from the following description and the accompanying drawings.

### BRIEF DESCRIPTION OF THE DRAWINGS

The invention will be described in more detail with reference to the enclosed drawings, wherein:

FIG. 1 illustrates a perspective view of a fluid distribution assembly fluidly coupled with a fluid source, in accordance with an embodiment which is not encompassed by the wording of the claims but is considered as useful for understanding the invention;

FIG. 2 illustrates a perspective view of a fluid source, in accordance with an aspect of the present disclosure;

FIG. 3 illustrates a perspective view of a fluid distribution assembly, in accordance with an embodiment which is not encompassed by the wording of the claims but is considered useful for understanding the invention;

FIG. 4A illustrates a perspective exploded view of an exemplary embodiment of a fluid distribution assembly, in accordance with an aspect of the present disclosure;

FIG. 4B illustrates a perspective view of a fluid distribution assembly of FIG. 4A, in accordance with an aspect of the present disclosure;

FIG. 5 illustrates another perspective view of a fluid distribution assembly of FIG. 4A, in accordance with an aspect of the present disclosure;

FIG. 6 illustrates a perspective view of a fluid distribution assembly fluidly coupled with a connector, in accordance with an embodiment which is not encompassed by the wording of the claims but is considered as useful for understanding the invention;

FIG. 7 illustrates another perspective view of a fluid distribution assembly fluidly coupled with a connector, in accordance with an embodiment which is not encompassed by the wording of the claims but is considered useful for understanding the invention;

FIG. 8 illustrates a perspective view of a fluid distribution assembly being fluidly coupled with a fluid source, in accordance with an embodiment which is not encompassed by the wording of the claims but is considered useful for understanding the invention;

FIG. 9 illustrates a cross-sectional view of a fluid source fluidly coupled with a fluid distribution assembly, in accordance with an embodiment which is not encompassed by the wording of the claims but is considered useful for understanding the invention; and

FIG. 10 illustrates a perspective view of a fluid source fluidly coupled with a fluid distribution assembly of FIGS. 4A and 4B, in accordance with an aspect of the present disclosure.

### DESCRIPTION OF EMBODIMENTS

The present invention will be described more fully hereinafter with reference to the accompanying drawings, in which example embodiments of the invention incorporating one or more aspects of the present invention are shown. This invention may, however, be embodied in many different forms and should not be construed as limited to the embodiments set forth herein; rather, these embodiments are provided so that this disclosure will be thorough and complete, and will fully convey the scope of the invention to those skilled in the art. For example, one or more aspects of the present invention may be utilized in other embodiments and even other types of structures and/or methods. In the drawings, like numbers refer to like elements.

Certain terminology is used herein for convenience only and is not to be taken as a limitation on the invention. For example, “upper”, “lower”, “front”, “rear”, “side”, “longitudinal”, “lateral”, “transverse”, “upwards”, “downwards”, “forward”, “backward”, “sideward”, “left,” “right,” “horizontal,” “vertical,” “upward”, “inner”, “outer”, “inward”, “outward”, “top”, “bottom”, “higher”, “above”, “below”, “central”, “middle”, “intermediate”, “between”, “end”, “adjacent”, “proximate”, “near”, “distal”, “remote”, “radial”, “circumferential”, or the like, merely describe the configuration shown in the Figures. Indeed, the components may be oriented in any direction and the terminology, therefore, should be understood as encompassing such variations unless specified otherwise.

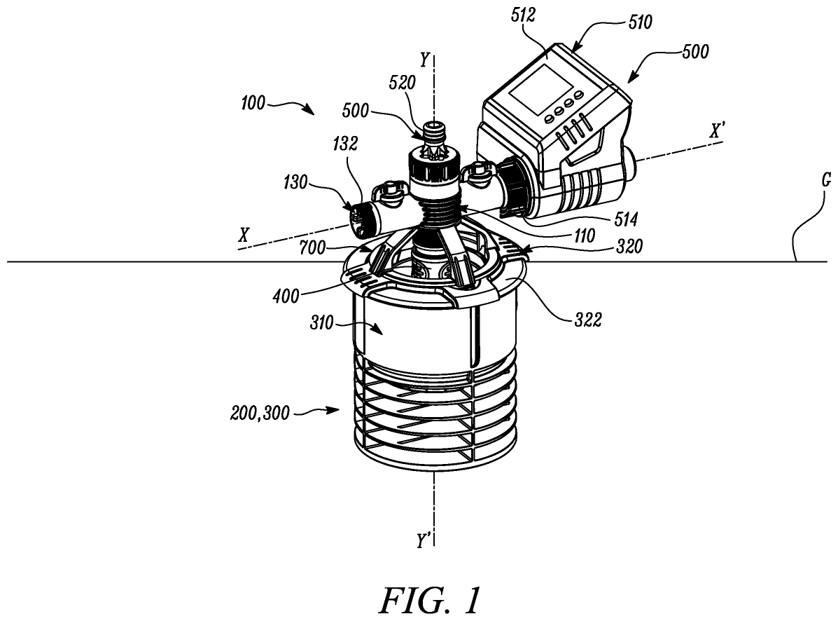

FIG. 1 illustrates a fluid distributor assembly 100 according to an embodiment which is not encompassed by the wording of the claims but is considered useful for understanding the invention. The fluid distributor assembly 100 is adapted to receive a fluid supply from a fluid source 200 (say a tap). The fluid distributor assembly 100 is further adapted to distribute the received fluid across multiple fluid outlets 130 for use with various industrial and domestic applications. The various industrial and domestic applications may include irrigation, cleaning, firefighting etc.

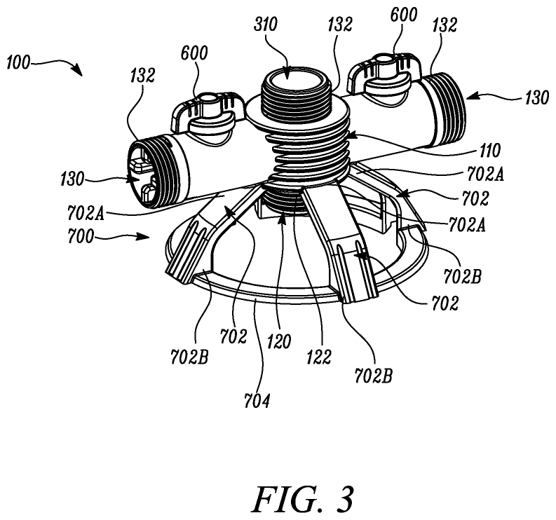

The fluid distributor assembly 100 includes a body 110. The body 110 may be made from one or more of metal, steel, plastic, or any other material known in the art. The body 110 defines a fluid inlet 120 (as shown in FIG. 3) adapted to be fluidly coupled with the fluid source 200 such that the fluid inlet 120 receives a fluid supply from the fluid source 200. The fluid inlet 120 is fluidly coupled with the fluid source 200 via a connector 400. Further, the connector 400 is fluidly coupled to a threaded portion 122 (as shown in FIG. 3) of the fluid inlet 120. The connector 400 may be made of any material such as plastic, a PVC material or any other suitable material known or used in the art to improve durability. The connector 400 may be made frost-proof or leakage proof to overcome damage due to frost in cold and chilly weather.

The fluid source 200 may be the source of a liquid (say a water) or a gas. In some embodiments, the fluid source 200 may be fully or partially embedded in the ground surface “G”. In some embodiments, the fluid source 200 may be housed above or on the ground surface “G” by any means known in the art. In some embodiments, the fluid source 200 may be attached or coupled to a wall surface (not shown).

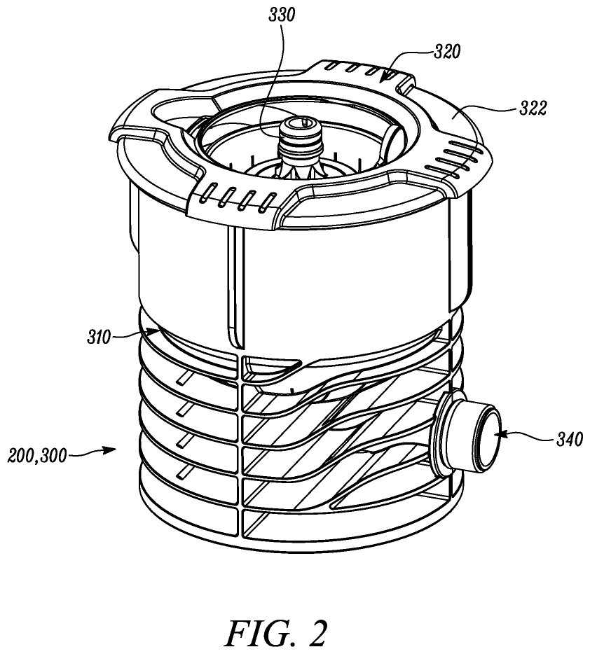

For the implementation of the present disclosure, the fluid source 200, as shown in FIGS. 1 and 2 is a water socket 300, and the fluid is water. The water socket 300 is partially embedded in the ground surface “G”. The water socket 300 allows discharge of the water from a water source (not shown) towards the fluid inlet 120 of the fluid distributor assembly 100. The water socket 300 includes a body 310. The body 310 of the present disclosure is cylindrical in shape. However, the body 310 may have any shape and size known in the art without limiting the scope of the present disclosure.

The body 310 includes an annular surface 320, a coupling nipple 330 and a water inlet 340. The annular surface 320 includes a housing ring 322. The water inlet 340 may be fluidly coupled with the water source via a series of pipes (not shown) embedded in the ground surface “G”. In some embodiments, the water source may be an underground water reservoir (not shown). However, the water source may any water source known in the art. Further, the water source may be housed above or below the ground surface “G” by any means known in the art.

In some embodiments, the coupling nipple 330 may be designed in a manner such that when the coupling nipple 330 is fluidly coupled with the fluid inlet 120 of the fluid distributor assembly 100 via the connector 400, the coupling nipple 330 may allow the water from the water inlet 340 to flow towards the fluid inlet 120. Furthermore, when the coupling nipple 330 is not fluidly coupled with the fluid inlet 120 of the fluid distributor assembly 100 via the connector 400, the coupling nipple 330 may disallow the water from the water inlet 340 to flow towards the fluid inlet 120.

With continued reference to FIG. 1, the body 110 of the fluid distributor assembly 100 defines at least one fluid outlet 130 fluidly coupled with the fluid inlet 120 (as shown in FIG. 3). For the implementation of the present disclosure, the at least one fluid outlet 130 are three fluid outlets 130 i.e., two horizontal fluid outlets 130 along X-X′ axis and one vertical fluid outlet 130 along Y-Y′ axis (as clearly shown in FIG. 3). The X-X′ axis is perpendicular to the Y-Y′ axis. Thus, the at least one fluid outlet 130 or two horizontal fluid outlets 130 which are along X-X′ axis distributes fluid in the horizontal direction. Similarly, the at least one fluid outlet 130 or one vertical fluid outlet 130 which is along Y-Y′ axis distributes fluid in the vertical direction.

However, the scope of the present disclosure should not be restricted by the number and directional orientation of the fluid outlets 130. In some embodiments, the at least one fluid outlet 130 may be along an axis (not shown) at an angle to the X-X′ axis or the Y-Y′ axis and may distribute fluid along any arbitrary direction.

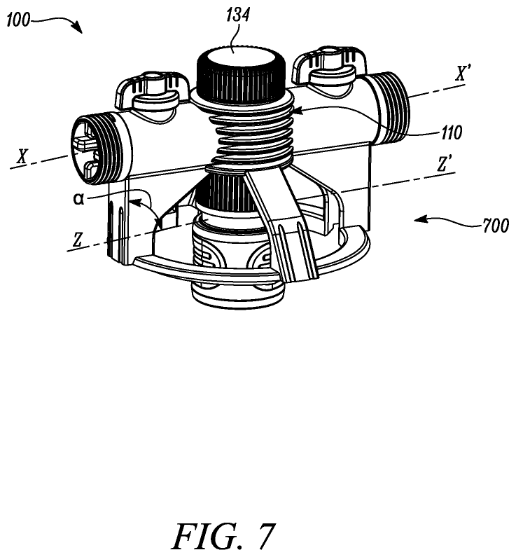

In some embodiments, the at least one fluid outlet 130 is adapted to fluidly couple with one or more fluid distribution components 500 or to be sealed with a cap 134 (as shown in FIG. 7). The cap 134 may prevent entry of foreign materials such as dirt etc. in the body 110 of the fluid distribution assembly 100 when the at least one fluid outlet 130 is not fluidly coupled with one or more fluid distribution components 500. Thus, the cap 134 may prevent unwanted blockages in the body 110 of the fluid distribution assembly 100.

The at least one fluid outlet 130 is fluidly coupled with the one or more fluid distribution components 500 to use the fluid (or water) for multiple industrial and domestic applications simultaneously. An operator may selectively couple the fluid distribution components 500 in the horizontal direction or the vertical direction or both the directions as per the application requirements. For example, the operator may selectively couple the fluid distribution components 500 in the horizontal direction when a plurality of sprinklers (not shown) is required to be fluidly coupled on the ground surface “G”. Further, the operator may not be forced to fluidly couple the fluid distribution component 500 (say a flexible hose pipe) in the vertical direction, which may sometimes lead to unwanted turning or twisting of the flexible hose pipe and make the flexible hose pipe less durable.

The one or more fluid distribution components 500 may be selected based on the application requirements, or operator preference. The one or more fluid distribution components 500 may be selected from a fluid computer 510, an aqua-stop nipple 520, a hose pipe (not shown), a connector that allows the connection of a hose (not shown), a sprinkler (not shown) etc. In some embodiments, the fluid distribution components 500 is the fluid computer 510. The fluid-computer 510 is interchangeably referred to as the water-computer 510 in the present disclosure and is connected directly to the at least one fluid outlet 130. The water-computer 510 includes a control panel 512 to allow selection and display of irrigation settings. The water-computer 510 may reliably control irrigation according to the irrigation settings (including time, frequency, and duration of the irrigation) selected by the operator. In some embodiments, a rain sensor or soil moisture sensor may be connected to the water computer 510 so that when it rains or if the soil is already moist enough, the programmed irrigation is cancelled, thus saving valuable water resources.

Further, in some embodiments, the fluid distribution components 500 is the aqua-stop nipple 520. The aqua-stop nipple 520 may be similar in construction or design of the coupling nipple 330. Furthermore, the aqua-stop nipple 520 may be similar in working to the coupling nipple 330. The aqua-stop nipple 520 may be fluidly coupled to the hose pipe (not shown) via the hose connector (not shown). The aqua-stop nipple 520 may allow or disallow the flow of fluid from the fluid source 200 to the hose pipe depending on the engagement or fluid coupling of the aqua-stop nipple 520 with the hose connector. For example, the aqua-stop nipple 520 may allow the flow of fluid from the fluid source 200 to the hose pipe, if the aqua-stop nipple 520 is fluidly coupled to the hose connector. Similarly, the aqua-stop nipple 520 may disallow the flow of fluid from the fluid source 200 to the hose pipe, if the aqua-stop nipple 520 is not fluidly coupled to the hose connector.

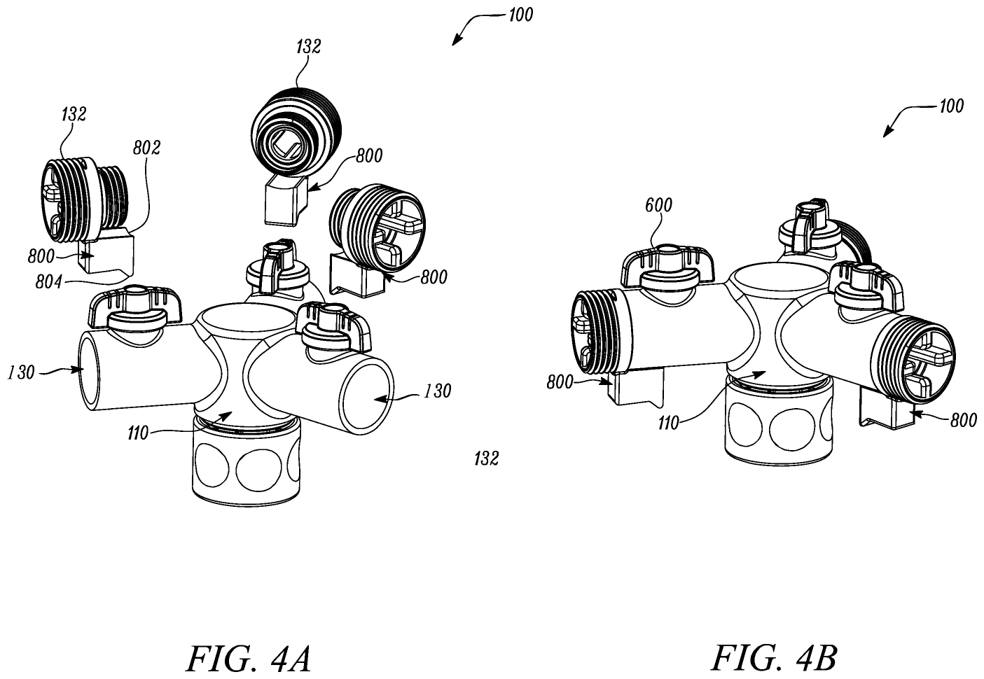

As further illustrated in FIGS. 1 and 3, the at least one fluid outlet 130 is advantageously provided with a threaded portion 132 to allow fluid coupling with the fluid distribution component 500 as most of the commonly used fluid distribution components 500 include the threaded portion for the fluid coupling. In some embodiments, as shown with FIGS. 4A and 4B, the threaded portion 132 is separately coupled to the at least one fluid outlet 130. The threaded portion 132 includes a small diameter area and a large diameter area such that the small diameter area is threaded engaged with the at least one fluid outlet 130 whereas the large diameter threaded area is threaded engaged to the fluid distribution component 500. The at least one fluid outlet 130 of the present disclosure are three fluid outlets 130 and accordingly the threaded portion 132 are three threaded portions 132 integrally formed or separately coupled with three fluid outlets 130. However, in actual implementation of the present disclosure, the number of fluid outlets 130 may vary according to the application requirement, body size, among other factors.

Further, in some embodiments, the small diameter area as discussed above may be threadless and coupled to the at least one fluid outlet 130 by friction-fitting, gluing, welding, or other coupling methods known and understood in the related art. In some embodiments, the large diameter area as discussed above may be threadless and may include a connector that allows the connection of a hose and the like. In some embodiments which are not encompassed by the wording of the claims but are considered as useful for understanding the invention, there may be no threaded portion 132. The threaded portion 132 may be replaced by a component with similar geometry i.e., the component having a small diameter area and a large diameter area such that the small diameter area may be coupled to the at least one fluid outlet 130 by friction-fitting, gluing, welding, or other coupling methods as discussed above, and the large diameter area may include a connector that allows the connection of a hose and the like for further fluid connections or couplings. In some embodiments, the at least one fluid outlet 130 may be coupled to the combination of different types of threaded portions 132 or an alternative component having no threaded portion as discussed above as per the application requirements.

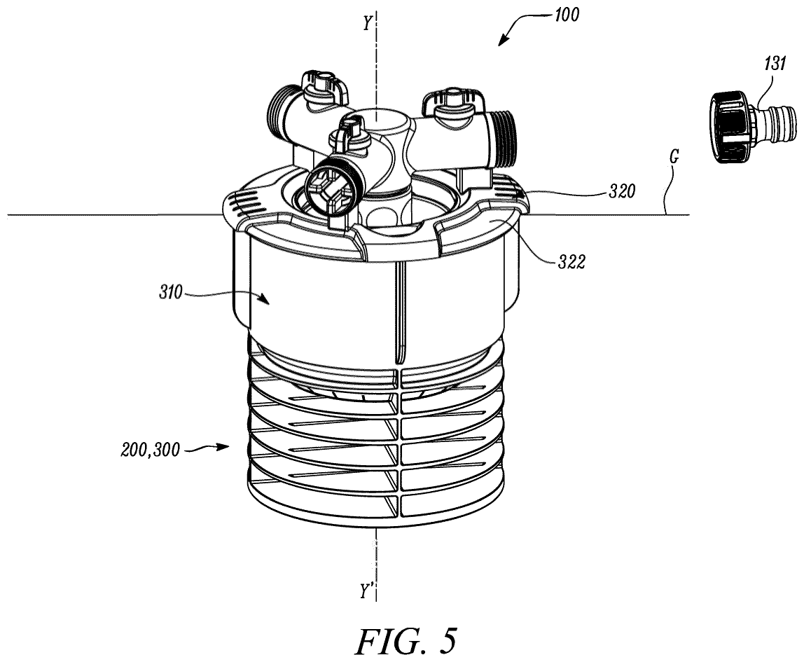

In the present disclosure, the fluid computer 510 is fluidly coupled with the at least one fluid outlet 130 by virtue of engagement between the threaded portion 132 of the at least one fluid outlet 130 and the threaded portion 514 of the fluid computer 510. Similarly, the aqua-stop nipple 520 is fluidly coupled with the at least one fluid outlet 130 by virtue of engagement between the threaded portion 132 of the at least one fluid outlet 130 and the internal threaded portion (not shown) of the aqua-stop nipple 520. Further, other known fluid distribution components 500 may be fluidly coupled to the at least one fluid outlet 130 by providing a coupler 131 (as shown in FIG. 5) with each of the at least one fluid outlet 130. The coupler 131 may be coupled to the at least one fluid outlet 130 due to threaded engagement, friction-fitting or by any other means known in the related art.

With continued reference to FIGS. 1 and 3, the at least one fluid outlet 130 is further provided with a manual shut-off valve 600. The fluid flow from the at least one outlet 130 may be selectively controlled using the manual shut-off valve 600. The manual shut-off valve 600 may be operated by the operator as per the application requirements. In some embodiments, the shut-off valve 600 may be an automatic shut-off valve. The automatic shut-off valve 600 may operate as per various fluid parameter requirements such as the flow rate requirements. The electronic set-up for the automatic shut-off valve 600 may include a plurality of sensors, microprocessors and related electronic circuitry commonly known and understood in the art.

The fluid coupling of the body 110 with the fluid source 200 (or the water socket 300) as illustrated so far in FIG. 1 may need a stabilizer frame 700 for providing the stability or shelter to the fluid coupling against external factors such as, but not limited to, strong wind, inadvertent force generated by the foot of the operator among others. Thus, the fluid distributor assembly 100 includes a stabilizer frame 700 disposed with the body 110.

The stabilizer frame 700, as illustrated in FIGS. 1 and 3 includes one or more stabilizer arms 702 having a first end 702A and a second end 702B such that the first end 702A is coupled to the body 110. The one or more stabilizer arms 702 extends away from the body 110. Further, a stabilizer ring 704 is coupled to the second end 702B of the one or more stabilizer arms 702. In some embodiments, one single stabilizer ring 704 is coupled to the one or more stabilizer arms 702. In some embodiments, the stabilizer ring 704 may be formed by discontinuous angular pieces that may couple with the second end 702B of the one or more stabilizer arms 702 to form the ring.

Thus, the stabilizer frame 700 forms a cage like structure to provide shelter to the fluid coupling between the fluid distributor assembly 100 and the fluid source 200. Further, the stabilizer frame 700 may prevent disengagement in the fluid coupling between the body 110 and the fluid source 200 due to any of the external factors know to the person skilled in the art.

The stabilizer frame 700 including the one or more stabilizer arms 702 and the stabilizer ring 704 may be made up or manufactured using a metallic material. The metals are advantageously stronger, harder, and durable. Thus, the metallic material of the stabilizer frame 700 may provide necessary strength, rigidity, and stability to the stabilizer frame 700. In some embodiments, the stabilizer frame 700 may be manufactured using a plastic material or any other suitable material known and understood in the related art.

In some embodiments which are not encompassed by the wording f the claims but are considered as useful for understanding the invention, the stabilizer frame 700 and the body 110 are manufactured in one piece using any suitable manufacturing technology known in the art. In some embodiments, the stabilizer frame 700 and the body 110 are manufactured separately and then coupled to each other by use of fasteners, welding or any other coupling method known and understood in the art.

With continued reference to FIG. 3, the one or more stabilizer arms 702 is three stabilizer arms 702. The number of the stabilizer arms 702 in the stabilizer frame may directly be related to the strength to the stabilizer frame 700. The number of the stabilizer arms 702 in the stabilizer frame may directly contribute to the strength to the stabilizer frame 700. The more the number of the stabilizer arms 702, the more is the rigidity of the stabilizer frame 700. However, there must be a substantial gap or space between the adjacent stabilizer arms 702 such that the operator may be able to grab and manipulate the connector 400 as and when required.

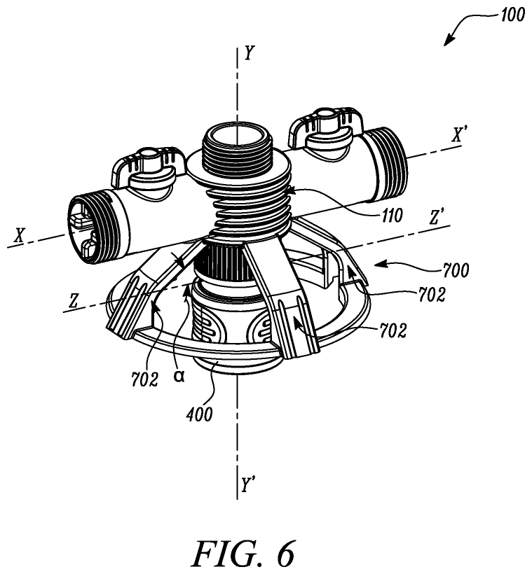

In some embodiments, as shown in FIG. 6, the one or more stabilizer arms 702 extends away from the body 110 in an angular manner. The one or more angular stabilizer arms 702 due to the angular geometry may provide enough space between the body 110 and the one or more stabilizer arms 702 to accommodate accessories such as, but not limited to, to the connector 400 to connect or fluidly couple the fluid distributor assembly 100 and the fluid source 200. The one or more stabilizer arms 702 may form an angle α with an axis Z-Z′ parallel to the X-X′ axis. The angle α is such that it allows the stabilizer ring to be disposed circumferentially around the body 110. In some embodiments as shown in FIG. 7, the angle α is 90 degrees. In this embodiment, the stabilizer frame 700 forms a relatively compact structure and may advantageously be used when the fluid distribution assembly 100 is employed in places with space constraints.

In an exemplary embodiment according to the present invention, as shown in FIGS. 4A and 4B, one or more stabilizer arms 800 are removably coupled with the threaded portion 132 separately coupled to the at least one fluid outlet 130. The removable coupling may be achieved by any means known in the art. The one or more stabilizer arms 800 includes first end 802 and second end 804. The first end 802 of the one or more stabilizer arms 800 is removably coupled with the threaded portion 132. Further, in this embodiment as well, the one or more stabilizer arms 800 extends away from the body 110. Further, the one or more stabilizer arms 800 is three stabilizer arms 800 removably coupled with each of the three threaded portions 132. Further, in some embodiments, the one or more stabilizer arms 800 may be removably or permanently coupled with the body 110. In some embodiments, the one or more stabilizer arms 800 may be removably or permanently coupled with the water socket 300.

As shown in FIGS. 4A and 4B, the one or more stabilizing arms 800 may be three stabilizing arms 800. Each of the one or more stabilizer arms 800 is coupled to a respective one of the threaded portions 132. The coupling may be formed by a ring which may be mounted around the threaded portion 132, particularly around the small diameter area adjacent to the large diameter area. The coupling may be formed by a ring portion being engaged on the small diameter area, before threadedly engaging the threaded portion 132 to the fluid outlet 130. Alternatively, the coupling of the stabilizer arm 800 to the threaded portion 132 may be formed by a partial ring portion which extends around at least a sub-portion of the circumference of the small diameter area of the threaded portion 132.

According to an exemplary embodiment of the invention, the stabilizer arm 800 may be coupled with the threaded portion 132 at the large diameter area.

FIG. 5 shows the fluid distribution assembly 100 mounted to a water socket 300 being the fluid source 200. Each of the three fluid outlets 130 has a threaded portion 132 and a respective stabilizer arm 800 mounted to the fluid outlet 130. The first end 802 of the stabilizer arm 800 is removably coupled to the threaded portion 132 and the second end 804 is engaged with a housing ring 332 of the water socket 300 being the fluid source 200.

The fluid distribution assembly 100 may be bought in a package (not shown). The package may be any reusable package known in the art. The package may be reused without the need of any recycling. The package may further include necessary accessories such as the connector 400, the aqua-stop nipple 520, the water socket 300, hose pipes etc.

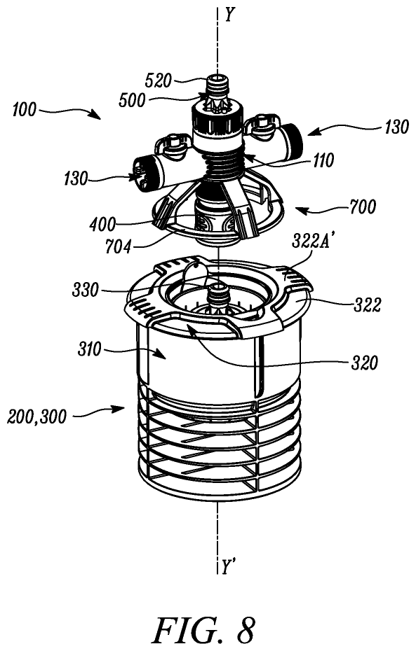

During implementation of the fluid distribution assembly 100, the operator may simply take out the fluid distribution assembly 100 and the associated accessories from the package. For example, the operator may fluidly couple the at least one fluid outlet 130 with the aqua-stop nipple 520. Further, the operator may fluidly couple the fluid inlet 120 with the connector 400. Furthermore, the operator may embed the water socket 300 in the ground surface “G”. The exemplary embodiment is illustrated in FIG. 8.

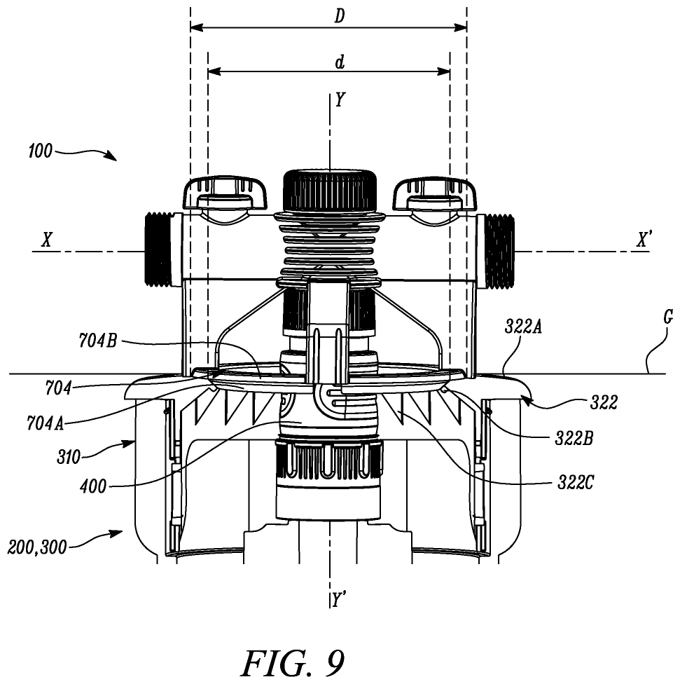

Further, in this exemplary embodiment of the FIG. 8, the operator may bring the assembled fluid distribution assembly 100 (i.e., the body 110 fluidly coupled with the socket 400) towards the coupling nipple 330 of the water socket 200 such that the connector 400 is fluidly coupled with the coupling nipple 330 along the Y-Y′ axis. Upon coupling, the stabilizer frame 700 forms the cage like structure to provide shelter to the fluid coupling between the fluid distributor assembly 100 and the fluid source 200 (or the water socket 300) against external factors, such as the bad weather. Further, the stabilizer ring 704 engages with the housing ring 322 positioned on the annular surface 320 of the body 310 of the water socket 300. As illustrated in FIG. 9, the stabilizer ring 704 includes an inner portion 704A and an outer portion 704B. The diameter “d” of the inner portion 704A and the diameter “D” of the outer portion 704B is such that the diameter “d”<diameter “D”. Further, the outer portion 704B is above the inner portion 704A when seen along the axis Y-Y′ in the direction away from the ground surface “G”.

With continued reference to FIG. 9, the housing ring 322 includes a flat surface portion 322A with equally spaced protrusions 322A′ (as shown in FIG. 8) and an annular slanted rib portion 322B. The flat surface portion 322A and the slanted rib portion 322B are supported by a plurality of ribs 322C circumferentially disposed on an inner side of the annular surface 320 of the water socket 300. Upon engagement between the coupling nipple 330 (as shown in FIG. 8) of the water socket 300 and the connector 400, the outer portion 704B of the stabilizer ring 704 engages with the flat surface portion 322A of the housing ring 322. Further, the inner portion 704A of the stabilizer ring 704 engages with the slanted rib portion 322B of the housing ring 322. Thus, if a force is applied vertically to the fluid distributor assembly 100 along the vertical Y-Y′ axis or along the horizontal X-X′ axis, the engagement between the coupling nipple 330 of the water socket 300 and the connector 400 may be prevented from disengagement. Further, the connector 400 or the coupling nipple 330 may be prevented from breakage or damage.

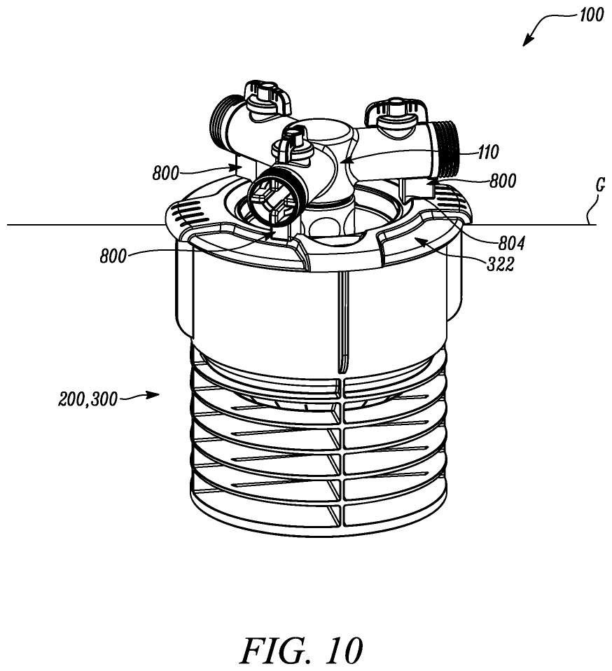

FIG. 10 illustrates the fluid distribution system 100 with the one or more stabilizer arms 800 of FIGS. 4A and 4B. The implementation of the fluid distribution system 100 is carried out in nearly similar manner as described in detail above. The difference lies due to the absence of the stabilizer ring 704. In this embodiment, the second end 804 of the one or more stabilizer arms 800 has nearly pointed shape and directly engages with the housing ring 322. Further, the one or more stabilizer arms 800 may also transmit forces to the water socket 300 in the vertical direction. The one or more stabilizer arms 800 thus prevent sideways dislocation of the body 110 of the fluid distribution assembly 100 relative to the fluid source 200 (or water socket 300) upon establishment of the fluid coupling.

As depicted in FIG. 10, each of the three stabilizer arms 800 is removably coupled with the threaded portion 132 with its first end 802. Additionally, the second end 804 of each of the three stabilizer arms 800 is coupled with the water socket 300.

Thus, the fluid distribution assembly 100 of the present disclosure is an easy to couple multi-way fluid distributor assembly 100. The fluid distribution assembly 100 is fluidly coupled to any fluid source 200 using the connector 400. The fluid distribution assembly 100 allows the utilization of fluid from the fluid source 200 for multiple applications simultaneously. Further, the outflow of the fluid from the at least one fluid outlet 130 of the fluid distribution assembly 100 is selectively controlled by the one or more shut-off valves 600. Furthermore, the fluid distribution assembly 100 includes the stabilizer frame 700 (or simply the one or more stabilizer arms 800) to provide stability to the fluid coupling between the fluid distributor assembly 100 and the fluid source 200 against external factors.

In the drawings and specification, there have been disclosed preferred embodiments and examples of the invention and, although specific terms are employed, they are used in a generic and descriptive sense only and not for the purpose of limitation of the scope of the invention being set forth in the following claims.

### LIST OF ELEMENTS

100 Fluid Distributor Assembly
110 Body
120 Fluid Inlet
122 Threaded Portion
130 Fluid Outlet
131 Coupler
132 Threaded Portion
134 Cap
200 Fluid Source
300 Water Socket
310 Body
320 Annular Surface
322 Housing Ring
322A Flat surface portion
322A′ Protrusions
322B Annular Slanted rib portion
322C Ribs
330 Coupling Nipple
340 Water Inlet
400 Connector
500 Fluid Distribution Component
510 Fluid Computer/Water Computer
512 Control Panel
514 Threaded Portion
520 Aqua-stop Nipple
600 Shut-Off Valve
700 Stabilizer Frame
702 Stabilizer Arms
702A First End
702B Second End
704 Stabilizer Ring
704A Inner Portion
704B Outer Portion
800 Stabilizer Arms
802 First End
804 Second End
G Ground Surface
X-X′ Axis
Y-Y′ Axis
Z-Z′ Axis
α Angle
d Diameter
D Diameter

1. A fluid distributor assembly comprising:
a body;
the body defining a fluid inlet adapted to receive a fluid supply from a fluid source;
the body defining at least one fluid outlet fluidly coupled with the fluid inlet;
wherein the at least one fluid outlet is provided with a threaded portion to allow fluid coupling with a fluid distribution component; wherein the fluid distributor assembly further includes one or more stabilizer arms extending away from the body, and
wherein a first end of the one or more stabilizer arms is removably coupled with the threaded portion.

2. The fluid distribution assembly according to claim 1,
wherein the threaded portion is separately coupled to the at least one fluid outlet.

3. The fluid distribution assembly according to claim 1,
wherein the one or more stabilizer arms are removably or permanently coupled with the fluid source.

4. The fluid distribution assembly according to claim 1,
wherein a second end of the one or more stabilizer arms has a substantially pointed shape and directly engages with a housing ring of the fluid source.

5. The fluid distributor assembly of claim 1,
wherein the one or more stabilizer arms extends away from the body in an angular manner.

6. The fluid distribution assembly according to claim 1,
wherein the one or more stabilizer arms are three stabilizer arms.

7. The fluid distribution assembly according to claim 1,
wherein the at least one fluid outlet are three fluid outlets.

8. The fluid distribution assembly according to claim 1,
wherein a number of the one or more stabilizer arms is equal to a number of the at least one fluid outlet.

9. The fluid distributor assembly of claim 1,
wherein the at least one fluid outlet is adapted to fluidly couple with one or more fluid distribution components.

10. The fluid distributor assembly of claim 9,
wherein the one or more fluid distribution components is selected from a fluid computer, a hose pipe, a connector that allows the connection of a hose connector, and a sprinkler.

11. The fluid distributor assembly of claim 1,
wherein the at least one fluid outlet is further provided with a manual shut-off valve.

12. The fluid distributor assembly of claim 1,
wherein the at least one fluid outlet distributes fluid in a horizontal direction.

13. The fluid distributor assembly of claim 1,
wherein the at least one fluid outlet distributes fluid in a vertical direction.
